(19) United States
(12) Patent Application Publication
(10) Pub. No.: US 2026/0104557 A1
(43) Pub. Date: Apr. 16, 2026

(54) FIBER OPTIC EXTENDER PORTS HAVING AN ENDCAP ALONG WITH ASSEMBLIES AND METHODS OF MAKING THE SAME

(71) Applicant: CORNING RESEARCH & DEVELOPMENT CORPORATION, Corning, NY (US)

(72) Inventors: Micah Colen Isenhour, Lexington, NC (US); Zachary Michael Thompson, Austin, TX (US)

(21) Appl. No.: 19/422,835

(22) Filed: Dec. 17, 2025

Related U.S. Application Data
(63) Continuation of application No. PCT/US2024/034575, filed on Jun. 19, 2024.
(60) Provisional application No. 63/511,218, filed on Jun. 30, 2023.

(51) Int. Cl. G02B 6/38

(52) U.S. Cl. CPC G02B 6/3874; G02B 6/3831; G02B 6/3849

(57) ABSTRACT

Extender ports comprising one or more connection ports having associated securing features for engaging external fiber optic connectors along with methods for making the same are disclosed. In one embodiment, the shell defines a cavity and comprises a barrel and at least one endcap having an opening that is configured to receive an external fiber optic connector. The extender port comprises a shell defining a cavity and having a barrel, a first endcap and a second endcap with respective openings on the endcaps configured to receive respective external fiber optic connectors for optical connection. Extender ports may have the first and second connection ports aligned for making an optical connection between external fiber optic connectors inserted into respective connection ports. Securing features are associated with the respective connection port passageways and are suitable for retaining and releasing the external fiber optic connectors from devices.

### CROSS-REFERENCE TO RELATED APPLICATIONS

This application is a continuation of International Patent Application No. PCT/US/2024/034575, filed on Jun. 19, 2024, which claims the benefit of priority of U.S. Provisional Application Ser. No. 63/511,218, filed on Jun. 30, 2023, the content of which is relied upon and incorporated herein by reference in its entirety.

### FIELD

The disclosure is directed to fiber optic extender port devices providing at least one optical connection port for receiving an external fiber optic connector along with methods for making the same. More specifically, the disclosure is directed to fiber optic extender ports comprising a shell having a barrel and an endcap for providing one or more connection ports with a securing feature associated with the connection port(s) for securing external fiber optic connector(s) for optical mating.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G and the like. As optical fiber extended deeper into communication networks the need for making robust optical connections in outdoor applications in a quick and easy manner was apparent. To address this need for making quick, reliable, and robust optical connections in communication networks hardened fiber optic connectors such as the OptiTap® plug connector were developed.

Multiports were also developed for making multiple optical connections with hardened connectors. Prior art multiports have a plurality of receptacles mounted through a wall of the housing for protecting an indoor connector inside the housing that makes an optical connection to the external hardened connector of the branch or drop cable. The multiports provide a location where multiple connections may be made at a common terminal location.

The different branch or drop cables connected to the multiport may require different lengths to reach the desired connection locations at the other end. With factory-terminated solutions there are typically several lengths of drop cables that are offered, and the user can use the length of connectorized drop cable that best fits the link length required. However, this can require the craft to stock several different length drop cables and may result in excess lengths of cable that require slack storage of cable if the lengths are not well-matched to the link length required. Moreover, any excess cable length that requires storage may be difficult to accommodate where limited space is available, and the slack storage may be unsightly as well.

Consequently, there exists an unresolved need for new devices that allow flexibility for the network operators to quickly and easily make optical connections with custom lengths for extending or tailoring the reach of a link in an optical network while also addressing concerns related to limited space, organization, or aesthetics. The concepts disclosed herein provide a rugged and reliable extender port for making optical connections with external fiber optic connectors that is also quick and easy to assemble for manufacturing.

### SUMMARY

The disclosure is directed to extender ports comprising at least one connection port configured for receiving an external fiber optic connector for optical connection. The extender port comprises a shell defining a cavity, and the shell comprises a barrel and at least one endcap that cooperates with the barrel. The extender port also comprises a respective securing feature(s) associated with the connection port(s) that may translate for securing or releasing the external fiber optic connector. Generally speaking, the extender ports comprise at least one connection port defined by an optical connector opening extending into a cavity of the shell of the extender port along with a securing feature 310 associated with the respective connection port.

The extender ports disclosed may have any suitable construction disclosed herein for providing one or more connection ports. For instance, the shell can define the necessary structure for making an optical connection when receiving the external fiber optic connectors, but using further components or features may be beneficial if desired. By way of example, the extender port may be weatherproof or not as desired. Likewise, extender port may also other features or components such as keying features for inhibiting a non-compliant connector from being inserted and potentially causing damage to the device or not as desired.

The disclosure is directed to extender port for making an optical connection with an external fiber optic connector. The extender port comprises a shell comprising a barrel and at least one end cap comprising an opening where the shell defines a cavity. A first connection port is disposed on the extender port with the at least one connection port comprising an optical connector opening extending from the opening of the at least one endcap into the cavity of the extender port and defining a first connection port passageway. At least one securing feature associated with the first connection port passageway and a least one securing feature resilient member for biasing a portion of the at least one securing feature.

The disclosure is also directed to an extender port for making an optical connection with an external fiber optic connector. The extender port comprises a shell comprising a barrel, a first end cap comprising a first opening, a second endcap comprising a second opening with the shell defining a cavity. A first connection port is disposed on the extender port with the first connection port comprising a first optical connector opening extending from the opening of the first endcap into the cavity and defining a first connection port passageway. A second connection port is disposed on the extender port with the second connection port comprising a second optical connector opening extending from the opening of the second endcap into the cavity and defining a second connection port passageway with the second connection port passageway being aligned with the first connection port passageway. At least one securing feature associated with the first connection port passageway and the least one securing feature capable of translating within a portion of the shell.

The disclosure is further directed to an extender port for making an optical connection with an external fiber optic connector. The extender port comprises a shell comprising a barrel, a first end cap comprising a first opening, a second endcap comprising a second opening with the shell defining a cavity. A first connection port is disposed on the extender port with the first connection port comprising a first optical connector opening extending from the opening of the first endcap into the cavity and defining a first connection port passageway. A second connection port is disposed on the extender port with the second connection port comprising a second optical connector opening extending from the opening of the second endcap into the cavity and defining a second connection port passageway with the second connection port passageway being aligned with the first connection port passageway. A first seal is disposed between the first endcap and the barrel, and a second seal disposed between the second endcap and the barrel. At least one securing feature associated with the first connection port passageway.

The disclosure is also directed to an extender port for making an optical connection with an external fiber optic connector. The extender port comprises a shell comprising a barrel, a first end cap comprising a first opening, a second endcap comprising a second opening with the shell defining a cavity comprising a passageway between the first opening and the second opening. A first connection port is disposed on the extender port with the first connection port comprising a first optical connector opening extending from the opening of the first endcap into the cavity and defining a first connection port passageway. A second connection port is disposed on the extender port with the second connection port comprising a second optical connector opening extending from the opening of the second endcap into the cavity and defining a second connection port passageway with the second connection port passageway being aligned with the first connection port passageway. At least one securing feature associated with the first connection port passageway and the least one securing feature comprises a bore and is capable of translating within a portion of the shell. The at least one securing feature translates from a retain position to an open position as a suitable fiber optic connector is inserted into the at least one connection port.

The disclosure is also directed to an extender port for making an optical connection with an external fiber optic connector that comprises a shell comprising a barrel, a first end cap comprising a first opening, a second endcap comprising a second opening with the shell defining a cavity. A first connection port is disposed on the extender port with the first connection port comprising a first optical connector opening extending from the opening of the first endcap into the cavity and defining a first connection port passageway. A second connection port is disposed on the extender port with the second connection port comprising a second optical connector opening extending from the opening of the second endcap into the cavity and defining a second connection port passageway with the second connection port passageway being aligned with the first connection port passageway. A ferrule alignment sleeve is disposed within the cavity of the shell, and at least one securing feature associated with the first connection port passageway and the least one securing feature comprises a bore and a locking feature. The securing feature is capable of translating within a portion of the shell and translates from a retain position to an open position as a suitable fiber optic connector is inserted into the at least one connection port.

The disclosure is further directed to an extender port for making an optical connection with an external fiber optic connector comprising a shell having a barrel, a first end cap comprising a first opening, a second endcap comprising a second opening with the shell defining a cavity. A first connection port comprising an optical connector opening extending from an outer surface of the extender port to the cavity and defining a first connection port passageway. A second connection port comprising a second optical connector opening extending from an outer surface of the extender port to the cavity and defining a second connection port passageway with the second connection port passageway being aligned with the first connection port passageway. A first securing feature associated with the first connection port passageway, and the first securing feature comprising a locking member and an actuator, with the first securing feature is capable of translating relative to the shell, wherein the first securing features translates from a retain position to an open position as a suitable external fiber optic connector is inserted into the first connection port.

The disclosure is also directed to methods for making extender ports. One method of making an extender port comprises providing a shell comprising a barrel and first end cap comprising an opening configured for receiving an external fiber optic connector. The shell defines a cavity and a first connection port having an optical connector opening extending from the opening of the first endcap into the cavity and defining a first connection port passageway of the extender port. The method includes assembling a first securing feature into the cavity, so it is associated with a connection port passageway of the shell, installing at least one securing feature resilient member for biasing a portion of the first securing feature, and attaching the first endcap to the barrel. The method may include other optional steps including inserting a ferrule alignment sleeve into the barrel or inserting an adapter into the barrel for assembly. The securing feature may have any suitable locking feature for cooperating with the external fiber optic connector and securing the same for optical connection. Other steps for the methods are described here and may also comprise the other features disclosed herein.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure and are incorporated into and constitute a part of this specification. The drawings illustrate various embodiments and together with the description serve to explain the principles and operation.

### BRIEF DESCRIPTION OF THE FIGURES

FIG. 1 is an exploded view of an explanatory fiber optic extender port according to the concepts disclosed for optically mating one or more external fiber optic connectors using the fiber optic extender port;

FIG. 2 is a top view of the assembled fiber optic extender port of FIG. 1 showing respective securing features configured as push-buttons associated with the respective connection ports of the device;

FIG. 3 depicts a perspective view of the fiber optic extender port of FIG. 1 with external fiber optic connectors shown on opposing ends of the fiber optic extender port for insertion into the respective connection ports of the device;

FIG. 3A is a perspective view of another fiber optic extender port similar to FIG. 1 with a single connection port and a tether cable that is fixed to one end of the fiber optic extender port for making an optical connection with the tether cable using the extender port;

FIG. 4 is a cross-sectional view of the fiber optic extender port of FIG. 1 showing details and without external fiber optic connectors inserted into the respective connection ports of the device;

FIG. 5 is a perspective view of the barrel of the shell of the fiber optic extender port of FIG. 1;

FIG. 6 is a perspective view of the endcap of the shell that cooperates with the barrel;

FIG. 7 is a perspective view of a securing feature of the fiber optic extender port of FIG. 1;

FIG. 8 is perspective view of a portion of the adapter having a through passageway that captures a portion of the ferule alignment sleeve disposed within the cavity of the shell of the extender port of FIG. 1;

FIG. 9 is a bottom perspective view of the actuator of the securing feature that is configured as a push-button of the extender port of FIG. 1;

FIGS. 10-14 are perspective views of components of another shell for an explanatory fiber optic extender port according to the concepts disclosed for optically mating one or more external fiber optic connectors using the device;

FIG. 15 is a perspective view of a securing member for use with the barrel of the shell shown in FIGS. 10 and 11;

FIG. 16 is a cross-sectional view of the explanatory fiber optic extender port using the components of FIGS. 10-15 showing details of the device; and

FIG. 17 a perspective view of another fiber optic extender port similar to FIGS. 1-3 using a shell having a polygonal profile adjacent to the ends of the device.

FIG. 18 depicts another extender port having one or more end caps that uses a different push-button actuator for translating the securing member and releasing a fiber optic connector from the device along with dust covers for the connection ports;

FIG. 19 a quarter-sectional view of the extender port of FIG. 18 with the different push-button actuator for translating the securing member and releasing a fiber optic connector from the device;

FIG. 20 is detailed sectional view of the extender port of FIGS. 18 and 19 showing the actuator having arcuate cantilevered arms disposed within the securing feature guide of the shell and shown without a sealing member;

FIGS. 21 and 22 are a perspective views of the actuator shown in the devices of FIGS. 18-20 and 24 and depict the plurality of arcuate cantilevered arms each having a respective latch used for retaining the actuator in the shell of the devices and used for releasing the optical mating;

FIG. 23 is a schematic representation of the actuator of FIG. 9 assembled into a shell and showing the flex length and the flex direction of the cantilevered arms used for the actuator;

FIG. 24 is a schematic representation of the actuator of FIGS. 18-20 assembled into a shell and showing the flex length and the two flex directions for the latches disposed on the arcuate cantilevered arms for comparison with FIG. 23; and

FIG. 25 is a cross-sectional view of a terminal having connection ports for receiving external fiber optic connectors and making optical connections that is assembled with the actuator of FIGS. 18-20.

### DETAILED DESCRIPTION

Reference will now be made in detail to the embodiments of the disclosure, examples of which are illustrated in the accompanying drawings. Whenever possible, like reference numbers will be used to refer to like components or parts.

The concepts for the devices disclosed herein are suitable for making at least one optical connection for indoor, outdoor or other environments as desired. Generally speaking, the devices disclosed and explained in the exemplary embodiments are extender ports, but the concepts disclosed may be used with any suitable device as appropriate. The extender ports disclosed comprise at least one connection port and a securing feature associated with the connection port that is configured for retaining an external fiber optic connector received by the connection port for optical connection.

As used herein, the term “extender port” means a device comprising a first connection port for receiving a fiber optic connector and configured for making an optical connection. In one embodiment, the extender port has a first connection port and a second connection port that are aligned for making an optical connection between the two external fiber optic connectors received in the respective connection ports of the device. Consequently, the extender port is advantageous for customizing or extending the length of an optical link by optically connecting two connectorized cable ends with the extender port, thereby providing further flexibility to the network provider for deployments. In other embodiments, the extender port can be fixed to a tether cable for optical connection with an external connector of a connectorized cable, thereby providing a connection node for the network when desired.

The concepts disclosed advantageously allow compact form-factors for the extender ports along with quick and easy assembly using a shell that defines a cavity. The shell comprises a barrel and at least one endcap having an opening configured for receiving the external fiber optic connector therethrough. The extender port may also be weatherproof for providing a robust package that is suitable for outside plant applications if desired or not.

The extender port also has one or more securing features associated with the respective connection port(s) of the device for securing and releasing the external fiber optic connector. Generally speaking, the securing features disclosed for use with extender ports herein may comprise one or more components with at least one component translating for releasing or securing the external fiber optic connector to the device. Specifically, the securing feature is capable of translating with respect to the shell. The securing feature may directly cooperate with a suitable portion of a connector housing of the external fiber optic connector or the like for securing and allowing an optical connection. The securing features disclosed herein for extender ports engage directly with a portion of the external fiber optic connector without conventional structures like prior art devices that require the turning of a coupling nut, bayonet or the like on the external connector or port. The securing features may also be biased to a retain position using a securing feature resilient member if desired for convenient operation or not.

As used herein, “securing feature” of the device excludes threads and features that cooperate with bayonets on an external fiber optic connector. Thus, the extender ports disclosed are compact and may be closely spaced together if needed because the space and structure needed for turning a threaded coupling nut or bayonet is not necessary for making the optical connection. The compact form-factors may allow the placement of the devices in tight spaces in indoor, outdoor, buried, aerial, industrial or other applications while advantageously providing a device having at least one connection port with a robust and reliable optical connection in a removable and replaceable manner for flexibility in the network. Since the connector footprint used with the extender ports disclosed does not require the bulkiness of a coupling nut or bayonet, the fiber optic connectors used with the devices disclosed herein may also be significantly smaller than conventional fiber optic connectors.

The extender port may also optionally include a keying portion for rotational alignment with the external fiber optic connector received into the connection port. Further, the keying portion of the connection port may inhibit damage to the connection port of the extender port by inhibiting the insertion of a non-compliant connector while also ensuring the correct rotational alignment for inserting the external fiber optic connector into the device. The keying portion may also aid the user during blind insertion of the connector into the connection port of the device to determine the correct rotational orientation with respect to the connection port when a line of sight is not possible or practical for alignment. The keying portion may be an additive keying portion (e.g., protrusion) to the primitive geometric round shape of the connection port passageway such as a male key on the. However, the concepts for keying of the connection ports may be modified for different connector designs or be used without a keying portion as well.

Although shown as single fiber ports, the concepts for the extender connector ports using shells having endcaps disclosed may be used with multifiber connection ports or designs if desired by being configured for optically mating multifiber ferrules. Several extender ports may also be located at a common location and mounted using hardware like organizers or mounts for receiving individual extender ports such as using fasteners or snap-fitting into the mount for providing organization for the extender ports and the optical connections.

Likewise, the concepts disclosed are also scalable with multiple connection ports in a relatively small form-factor while still being rugged for demanding environments if desired. For instance, a device may have two or more connection ports in rows or columns of connection ports as part of a common shell or body for optically mating an array of external fiber optic connectors.

The concepts disclosed herein are suitable for optical networks such as for fiber to the home, business, node, 5G or the like, but are equally applicable to other optical applications as well including indoor, automotive, industrial, wireless, or other suitable applications. Additionally, the concepts disclosed may be used with any suitable fiber optic connector footprint that cooperates with the securing feature of the device. Various designs, constructions, or features for devices are disclosed in more detail as discussed herein and may be modified or varied as desired.

Further, the extender port may be used with other devices or communication networks for providing optical connectivity such as being a portion of a wireless device or network. Although, extender ports are shown and described for a single inline connection, the concepts are scalable to many in-line connection ports on a single device in a variety of arrangements or constructions if desired.

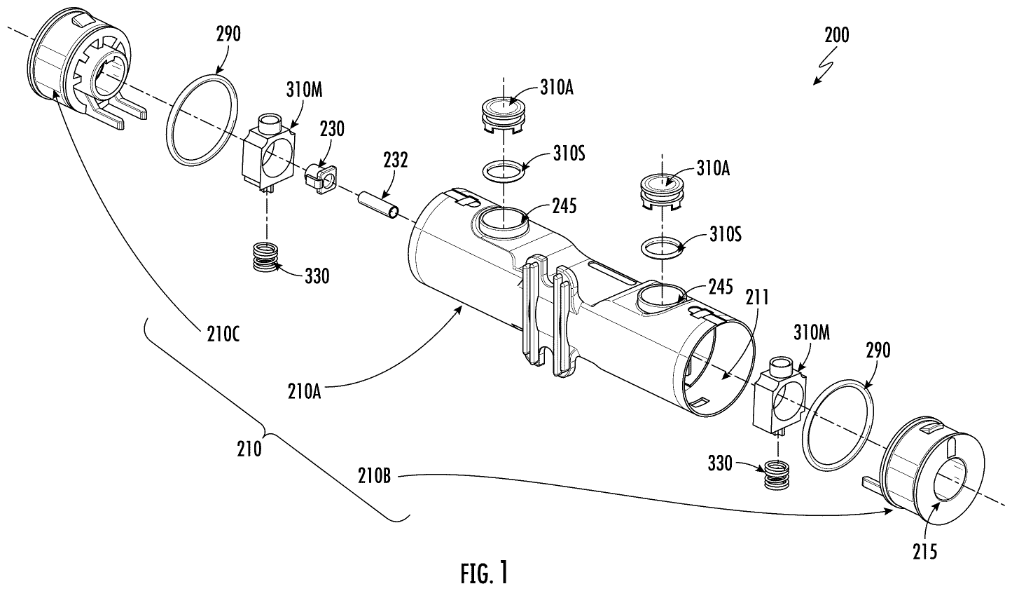

FIGS. 1-3 depict views of a first explanatory extender port 200 according to the concepts disclosed. FIG. 1 is an exploded view of extender port 200 useful for receiving and making an optical connection between external fiber optic connector(s) received into the extender port 200. The extender port 200 comprises a shell 210, at least one connection port 236, at least one securing feature 310 associated with a respective connection port passageway 233, and at least one securing feature resilient member 330 for biasing a portion of the at least one securing feature 310. Shell 210 comprises a barrel 210A and at least one endcap 210B, 210C comprising an opening 215, and the shell 210 defines a cavity 216 as best shown in FIG. 4.

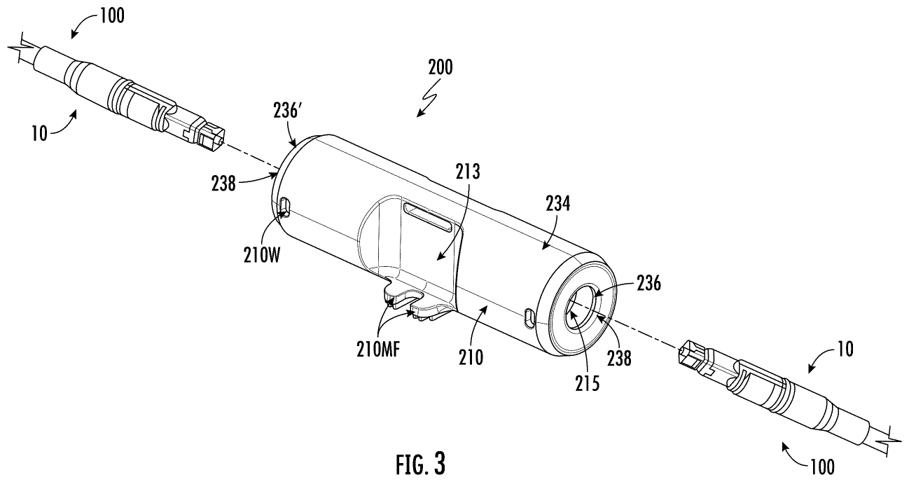

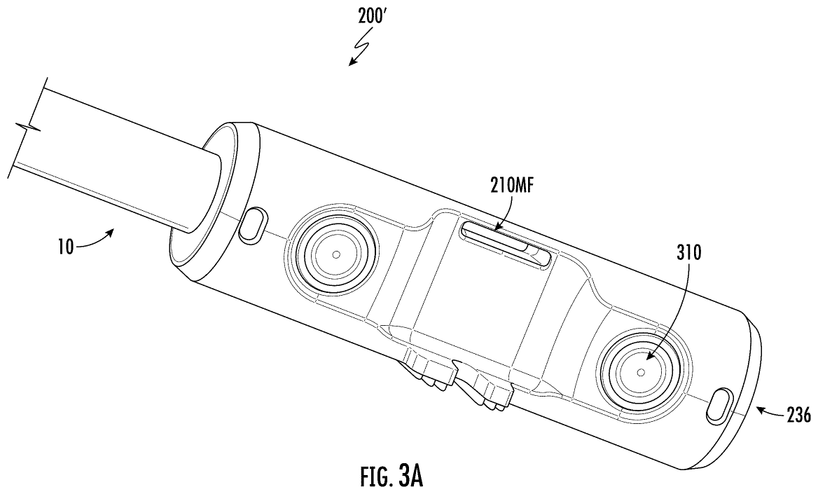

As shown, the extender port 200 of FIGS. 1-3 comprises a first connection port 236 and a second connection port 236′ that are aligned for making an optical connection between external fiber optic connectors 10 that are inserted from respective opposite ends of the extender port 200 as depicted in FIG. 3. In other embodiments, the extender port 200 may have a fixed cable or tether cable 100 fixed on one end and a single connector port 236 on the other end for receiving an external fiber optic connector for making an optical connection with optical fiber(s) of the fixed or tether cable such as shown in FIG. 3A.

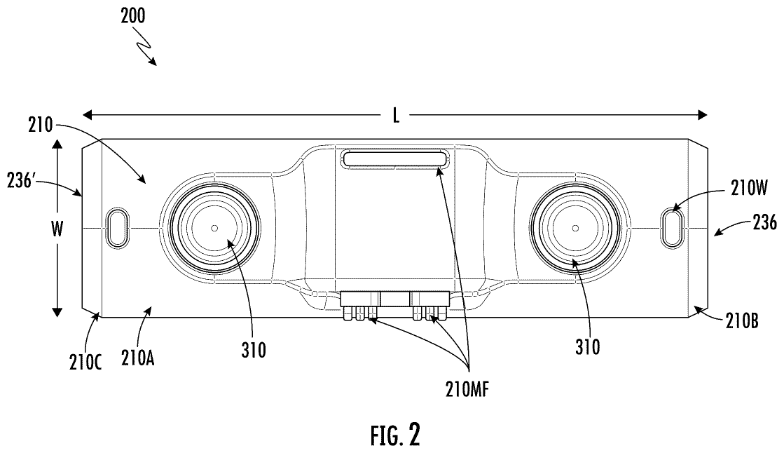

The one or more connection ports 236,236′ are positioned at respective longitudinal ends of the extender port 200 such as shown in FIG. 2. The connection ports 236 are configured for receiving and retaining external fiber optic connectors 10 for making one or more optical connections with the external fiber optic connectors 10 received within the extender port 200. Each respective connection port 236,236′ is associated with a respective connection port passageway 233 that extends into the extender port 200 from the opening 215 of the respective endcap 210B, 210C. As depicted in FIG. 3, the external fiber optic connectors 10 may be aligned for insertion from each respective end of the extender port 200 into the respective connection port passageway 233 of the respective connection ports 236,236′ for making an optical connection between the fiber optic connectors 10 received within the device.

Securing feature(s) 310 are associated with the respective connection port passageways 233 for cooperating with the external fiber optic connector 10 received by the extender port 200. As represented by vertical arrow in FIG. 4, the securing feature 310 may translate for releasing or securing the external fiber optic connector 10. The securing feature 310 advantageously allows the user to make a quick and easy optical connection at the connection port 236 of extender ports 200 by pushing the external fiber optic connector 10 into the respective connector port 236,236′ until it is secured by the securing feature 310. The securing feature 310 may also operate for providing a connector release feature when actuated such as by pushing downward on the securing feature 310.

Specifically, the external fiber optic connector 10 may be retained within the respective connection port 236,236′ of the device by pushing and fully-seating the external fiber optic connector 10 within the respective connection port 236,236′. To release the external fiber optic connector 10 from the respective connection port 236, 236′, the securing feature 310 is actuated by pushing downward to translate the securing feature 310 a suitable distance, thereby releasing the securing feature 310 from the connector housing and allowing the connector to be removed from the respective connection port 236, 236′. Stated another way, the at least one securing feature 310 is capable of releasing the external fiber optic connector 10 when translating with respect to the shell 210. The full insertion and automatic retention of the external fiber optic connector 10 may advantageously allow one-handed installation of the external fiber optic connector 10 by merely pushing the external connector into the connection port 236, 236′. The extender ports 200 disclosed accomplish this connector retention feature upon full-insertion by biasing the securing feature 310 to a retain position using a securing feature resilient member 330. However, other modes of operation for retaining and releasing the connector 10 are possible according to the concepts disclosed. For instance, the securing feature 310 may be designed to require actuation for inserting the external connector 10; however, this may require a two-handed operation.

Securing feature 310 may be designed for holding a minimum pull-out force for the external fiber optic connector 10. In some embodiments, the pull-out force may be selected to release the external fiber optic connector 10 before damage is done to the device or the external fiber optic connector 10. By way of example, the securing feature 310 associated with the connection port 236 may require a pull-out force of about 50 pounds (about 220N) before the external fiber optic connector 10 would release. Likewise, the securing feature 310 may provide a side pull-out force for connector 10 for inhibiting damage as well. By way of example, the securing feature 310 associated with the connection port 236 may provide a side pull-out force of about 25 pounds (about 110N) before the external fiber optic connector 10 would release. Of course, other pull-out forces such as 75 pounds (about 330N) or 100 (about 440N) pounds are possible along with other side pull-out forces as desired.

The securing features 310 disclosed herein may take many different constructions or configurations. By way of explanation, securing features 310 may be formed from a single component or a plurality of components that cooperate with suitable devices having an optical mating. The explanatory extender port depicted uses a two-piece securing feature 310 that comprises a securing member 310M and an actuator 310A such as shown in FIG. 1. Using a two-piece securing feature 310 allows for quick and easy assembly of the extender port 200. It is especially advantageous for suitable devices providing optical mating to use an actuator 310A that allows assembly from the exterior-side of the shell of the device.

The embodiment of FIG. 3A shows an extender port 200′ similar to the extender port 200 of FIG. 1, except is has a single connection port 236. The other end of the extender port 200 has a tether cable or the like attached in a manner so that is does not unmated using an actuator 310A.

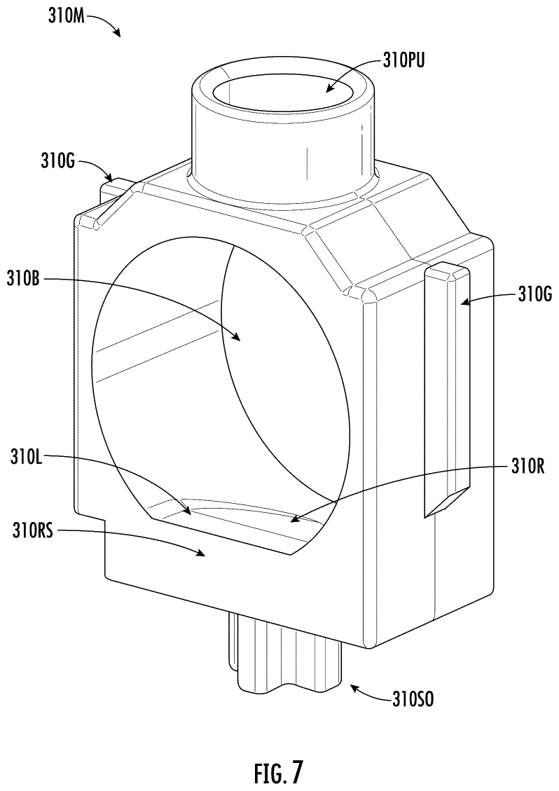

As shown in FIG. 4, securing feature 310 is biased to a retain position. Specifically, the securing feature 310 is biased in an upward direction using a securing feature resilient member 330 that is positioned between the securing feature 310 and shell 210. Consequently, a portion of securing feature 310 is capable of translating within a portion of the securing feature guide 245. Securing features 310 may translate in a vertical direction as represented by the vertical arrow in FIG. 4 for retaining and releasing the external fiber optic connector 10 in extender port 200. As depicted, the resilient members 330 are disposed under the securing member 310M for biasing the securing member 310M (and the actuators 310A) upwards to a normally retained position (RP). Securing feature 310 further includes a locking feature 310L (FIG. 7) that may engage external fiber optic connector 10.

Shell 210 has a relatively small size with a longitudinal length L and a width W as shown in FIG. 2. By way of example, and not limitation, dimensions for the explanatory embodiment may have a length of about 100 millimeters and width of about 30 millimeters, but other suitable dimensions are possible for the device.

Shell 210 comprises a body configured as barrel 210A and at least one endcap 210B. The barrel 210A comprises a passageway 211 that extends along a longitudinal axis extending from a first end 217 to a second end 219 of the barrel 210A. The at least one endcap 210B, 210C is sized for inserting a portion of the endcap 210B, 210C into the passageway 211 of the barrel 210A for assembly. Endcap 210B, 210C may be configured so that they fit into the barrel 210A in only one orientation to inhibit assembly in an incorrect orientation. Each endcap 210B, 210C also has a respective opening 215 that extends through the respective endcap 210B, 210C and is sized for receiving a portion of the external fiber optic connector 10 received by the device.

As best shown in FIG. 4, connection ports 236,236′ each comprise a respective optical connector opening 238 extending from an outer surface of the extender port 200 into a cavity 216 of the extender port 200 and defining respective connection port passageways 233. Generally speaking, a portion of the connection ports 236, 236′ are formed as a portion of the shell 210 such as being molded as a portion of shell 210. For instance, the shell 210 may comprise features for keying and/or guiding the external fiber optic connectors 10 into the extender port 200 for optical mating and/or aiding the assembly of components of the device. As shown, the barrel 210A may have a necked-down portion 213 disposed in a medial portion of the barrel 210A, and the necked-down portion 213 may form a portion of the connection ports 236,236′ adjacent to where the optical mating of the external fiber optic connector(s) 10 occur. Other components, or portions of components, of the device may also form a portion of the connection ports 236, 236′ or respective connection port passageways 233 as well such as endcaps 210B, 210C as depicted in FIG. 4.

Extender port 200 may include other components as desired or not. For instance, the extender port 200 may comprise an adapter 230 and/or a ferrule alignment sleeve 232 for receiving and aligning respective ferrules of the external fiber optic connectors 10. When assembled, the ferrule alignment sleeve 232 is disposed within the shell 210. Specifically, ferrule alignment sleeve 232 may fit into an alignment portion 211AP of the passageway 211 of barrel 210 if desired for used in the extender port 200, but it is possible to use the concepts disclosed herein without the ferrule alignment sleeve 232.

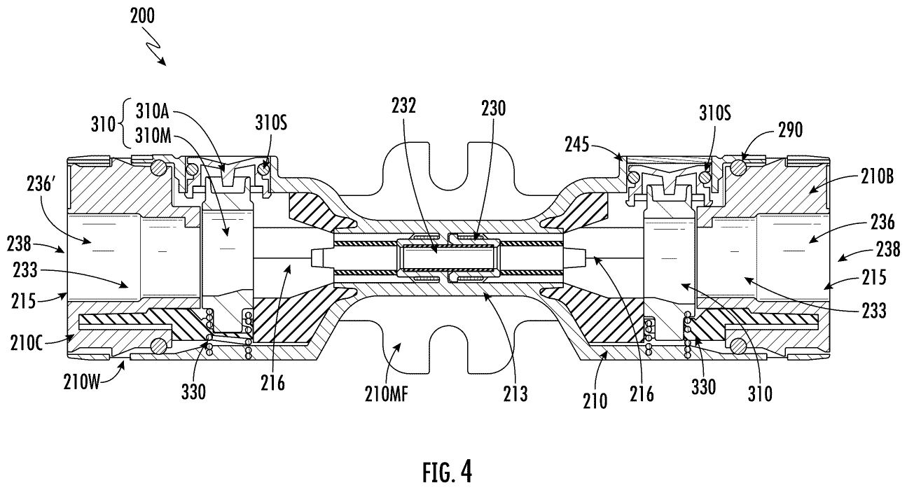

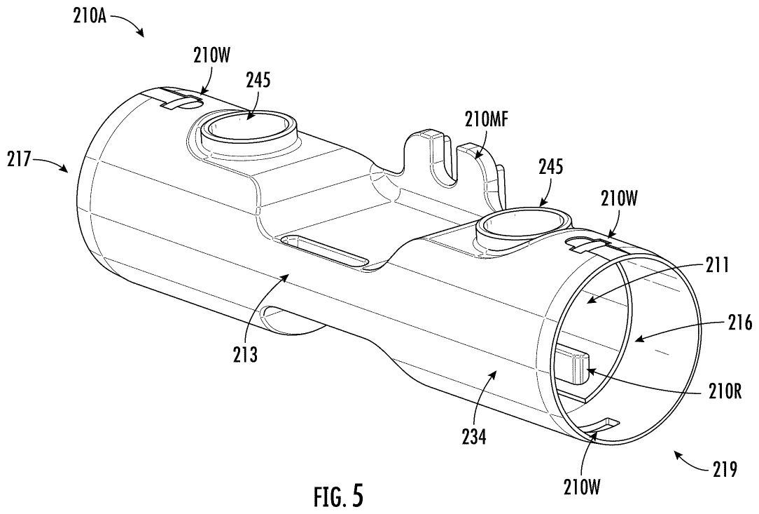

The adapter 230 may comprise separate components or be integrally formed as part of the shell 210 if desired. By way of explanation, all or a portion of an adaptor 230 may be formed as a portion of the barrel 210A or be configured as separate components as desired. As shown in the explanatory embodiment, the barrel 210A of shell 210 has a portion of the adaptor (not numbered) integrally formed as a portion of the barrel 210A, and the other portion of adapter 230 is formed as a separate component that is assembled into the barrel 210A. The adapter 230 cooperates with the barrel 210A for capturing the ferrule alignment sleeve 232 in a medial portion of extender port 200 using adapter 230. Specifically, half of the adapter 230 is formed internally within the passageway 211 of the barrel 210A as shown in FIG. 4. The ferrule alignment sleeve 232 is typically formed as a split sleeve for precision alignment of the mating ferrules of the external fiber optic connectors. However, it may be possible to omit the ferrule alignment sleeve 232 by integrating the structure and function into the shell 210, but there may impact the precision alignment of the mating ferrules or optical performance. In other embodiments, adapters 230A may be formed from several components, and received within the shell 210. Likewise, other structures or features may be integrally formed with the shell 210 or may use separate components as desired. In other variations, the ferrule alignment sleeve 232 may be pressed into the alignment portion of the passageway 211 of barrel 210 without any using further components. FIGS. 5-9 depict select components of the extender port 200 for explaining further details of the design.

FIG. 5 depicts a perspective view of barrel 210A. The barrel 210A or shell 210 may also include other features integrally formed with the barrel 210A if desired. Illustratively, FIG. 5 depicts rails 210R formed within the passageway 211 of the barrel 210A for aiding in the assembly of the endcaps 210B, 210C with the barrel 210A. Specifically, rails 210R may associated with each respective connection port 236,236′ of the device and are disposed within the passageway 211 of the barrel 210A running in a longitudinal direction on an internal sidewall such as shown if desired. Rails 210R of barrel 210A cooperate with other components of the extender port 200 for assembly. Rails 210R may be used for aiding with the rotational and/or positioning of the alignment of the securing member 310M within the passageway 211 of barrel 210A. By way of explanation, a portion of the securing member 310M may be disposed between the rails 210R on opposing sides of the internal sidewall of the barrel 210A. Rails 210R may also help with assembly for referencing the guides 210G of respective endcaps 210B, 210C if desired. Barrel 210A may also include one or more retention features 210W that cooperate with the endcaps 210B, 210C for securing the endcaps to barrel 210A. As depicted, barrel 210A may include one or more retention features 210W such as windows disposed on respective ends 217,219 for cooperating with corresponding retention features 210L such as latches disposed on the respective endcaps 210B, 210C of the shell 210. Other configurations of retention features are also possible such as having latches on the barrel 210 and windows on the endcaps 210B, 210C if desired. Although, the explanatory embodiment uses snap-features for retaining the endcaps 210B, 210C to barrel 210A for quick and easy assembly, other methods are possible such as an adhesive or fastener for retaining the endcaps 210B, 210C to the barrel 210A as desired.

One or more respective securing feature guides 245 extend from the outer surface 234 of extender port 200 and cooperate with the respective connection port passageways 233 of the extender port 200. Securing feature guide 245 is sized for receiving a portion of the securing feature 310 therein. Respective securing features 310 are associated with the connection port passageways 233 and have a portion of the securing feature 310 disposed within a portion of the securing feature guide 245 of the extender port 200. As shown, the securing feature guide 245 is formed as a portion of the barrel 210A as an aperture, and a portion of securing feature 310 is disposed within a portion of the securing feature guide 245. More specifically, the aperture of the securing feature guide 245 is sized so that a portion of the actuator 310A of securing feature 310 is disposed within a portion of the securing feature guide 245 as shown in FIG. 4.

Extender port 200 may also comprise one or more mounting features. As shown, barrel 210A may have one or more mounting feature 210MF formed integrally formed with the body of barrel 210A of shell 210 if desired. As best shown in FIG. 2 barrel 210A has a first mounting feature 210MF configured as a slot formed in the longitudinal direction located between the securing features 310 at the top for mounting the device using a zip-tie, strap or the like. Extender port 200 may also include a second mounting feature 210MF configured as a mounting tab located between the securing features 310 at the bottom for mounting the device using a fastener like a screw, bolt or the like. The mounting tab may provide a flat surface for mounting the device and may include a notch, opening or aperture for receiving a fastener. The barrel 210A or extender port 200 may also have other mounting features if desired as well.

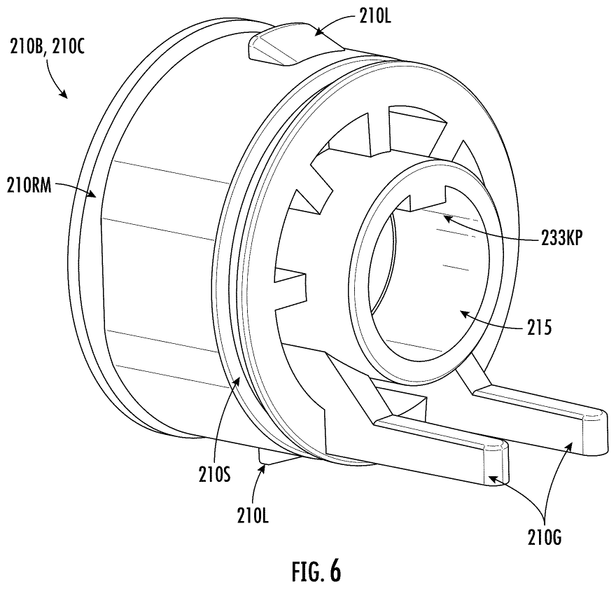

The connection port passageway 233 may also comprise a keying portion 233KP as part of the extender port 200 for ensuring the proper rotational orientation of the external fiber optic connectors 10 during insertion into the connection ports 236,236′. FIG. 6 is a perspective view of the endcap 210B, 210C of the shell 210 that cooperates with barrel 210A. As shown, endcap 210B, 210C may comprise a keying portion 233KP disposed within the opening of endcap 210B, 210C. Keying portion 233KP inhibits the insertion of a non-compliant connector into connection port 236,236′, thereby inhibiting damage that may be caused to the device by a non-compliant connector. Suitable external fiber optic connectors 10 have a complimentary keying feature that cooperates with the keying portion 233KP of extender port 200. Keying portion 233KP may be a protrusion or additive feature disposed within the connection port passageway 233 on the optical connector opening 238 side of the securing feature 310 and may take may suitable configuration if used. For instance, keying portion 233KP may be a simple protrusion as shown. In other embodiments, the keying portion 233KP may take the shape of a D-shaped opening to allow only a suitable connector 10 having a complimentary feature to be inserted into the connection port 236. The keying portion 233KP may also aid with blind mating the external fiber optic connector 10 into the connection port 236 since it only allows further insertion into the connection port 236 when the connector is in the proper rotational orientation.

As shown, keying portion 233KP is disposed forward of the securing feature 310 (i.e., before reaching the securing feature 310 when moving into the connection port 236,236′ from the external position) in the connection port passageway 233 upon entry into the passageway. The keying portion 233KP may have any suitable location in the connection port passageway 233 forward of the securing feature if used.

Any of the extender ports 200 disclosed herein may optionally be weatherproof by appropriately sealing seams of the shell 210 between components using any suitable means such as gaskets, O-rings, adhesive, sealant, welding, overmolding or the like. The explanatory embodiment may comprise an O-ring 290 disposed between the endcap 210B, 210C and the barrel 210A as shown in FIG. 1. Endcaps 210B, 210C may comprise a seat 210S that provides a surface for the O-ring 290 to seal against when assembled to the barrel 210A. Endcaps 210B, 210C may also include one or more retention features 210L for securing the endcaps 210B, 210C to the barrel 210A. The explanatory embodiment has the retention features 210L configured as latches that cooperate with the retention features on the barrel 210A that are configured as windows for snap-fit assembly in a quick and reliable manner. Moreover, the interface between the connection ports 236 and the dust cap or the external fiber optic connector 10 may be sealed using appropriate geometry and/or a sealing element such as an O-ring or gasket on the connector or dust cap. If the extender port 200 is intended for indoor applications, then the weatherproofing may not be required.

Endcaps 210B, 210C may also include a rim 210RM for inhibiting over-insertion of the endcaps 210B, 210C into barrel 210A. As shown, the rim 210RM is configured as an angled surface or shoulder near the back end of the endcaps 210B, 210C. The rim 210RM can be sized relative to the outer diameter of the barrel 210A for a smooth transition between on the outer surface 234 of the extender port 200 if desired.

Endcaps 210B, 210C may also include guides 210G extending from the endcaps 210B, 210C for allowing the endcaps 210B, 210C to be assembled to the barrel 210A in only one orientation. The explanatory embodiment comprises two guides 210G configured as spaced apart arms extending inward toward the medial portion of the extender port 200 when assembled. Other structures may be possible for guides 210G of the endcap 210B, 210C if used. Having the guides 210G spaced apart opposite of keying portion 233KP allows room for the securing member resilient member 330 and a portion of the securing member 310M to operate. The guides 310G may aid in the assembly of securing member resilient member 330 and securing member 310M by providing a pocket and/or support for the components during assembly. Specifically, the securing member resilient member 330 may be placed about a standoff 310SO on the bottom of the securing member 310M (FIG. 7) and then positioned on the guides 210G of the respective endcaps 210B, 210C before assembling the endcap 210B, 210C with the barrel 210A.

FIG. 7 is a perspective view of the securing member 310M of securing feature 310 for the explanatory fiber optic extender port 200. The perspective view of the securing member 310M in FIG. 7 is taken in the direction outward from the middle of the extender port 200 outward toward the opening 215 of the endcap 210B, 210C. Securing feature 310 comprises a locking feature 310L. Locking feature 310L cooperates with a portion of the external fiber optic connector 10 when it is fully-inserted into the respective connection port 236,236′ for securing the same. Specifically, the connector housing of external fiber optic connector 10 may have a cooperating geometry that engages the locking feature 310L of securing feature 310.

Securing feature 310 comprises a bore 310B that is aligned with the least one connection port passageway 233 when assembled as best shown in FIG. 4. Bore 310B is sized for receiving a suitable external fiber optic connector 10 therethrough for securing the same within the extender port 200 for optical connectivity. Bores or openings through the securing member 310M of securing feature 310 may have any suitable shape or geometry for cooperating with the respective external fiber optic connector 10. Bore 310B may also comprise features on the surface of the bore 310B for engaging with the external fiber optic connector 10 for securing the same within the respective connection port 236,236′.

As depicted in FIG. 7, locking feature 310L is disposed within bore 310B of securing member 310M. Specifically, locking feature 310L comprises a ramp 310R in this embodiment. The ramp 310R is integrally formed at a portion of the bore 310B with the ramp angling up when looking into the respective connection port 236, 236′ when assembled. The ramp 310R allows the external fiber optic connector 10 to push and translate the securing member 310M downward against the securing feature resilient member 330 as the external fiber optic connector 10 is inserted in the respective connection port 236,236′. Ramp 310R may have any suitable geometry such as a retention surface such as a ledge at the backside or the ramp 310R may lead to a flat portion before the retention surface. Once the locking feature 310L of the securing member 310M is aligned with the cooperating geometry of the of external fiber optic connector 10, then the securing feature 310M translates so that the locking feature 310L engages the respective locking feature of the external fiber optic connector 10.

As shown, locking feature 310L is configured as ramp 310RP that runs to a short flat portion, then to a ledge for creating the retention surface 310RS for engaging and retaining the external fiber optic connector 10 once it is fully-inserted into the connector port passageway 233 of the connection port 236. Consequently, the securing feature 310 is capable of moving to an open position (OP) when inserting a suitable connector 10 into the connector port passageway 233 since the connector housing 20 engages the ramp 310R pushing the securing feature 310M downward during insertion.

The securing member 310M translates from a retain position (RP) to an open position (OP) as a suitable external connector 10 is inserted into the respective connection port 236,236′ of the extender port 200. Once the external fiber optic connector 10 is fully inserted into the respective connector passageway 233, then the securing member 310M automatically moves to the retain position (RP) since it is biased upwards to the retain position by the securing feature resilient member 330. Stated another way, the securing feature 310 translates from the retain position to an open position as a suitable external fiber optic connector 10 is inserted into the respective connection port 236,236′. Then, when external fiber optic connector 10 is fully-seated the securing feature 310 is biased back to the retain position to secure the external fiber optic connector 10 in the respective connection port 236,236′. This advantageously allows a plug and play connectivity of the external fiber optic connectors 10 with extender port 200 without having to turn a coupling nut or a bayonet like conventional connectors. Thus, connections to the extender port 200 may be made faster and in positions that may be awkward with relative ease.

Locking feature 310L may comprises other suitable geometry for cooperating with the external fiber optic connector 10. For instance, locking feature 310L may have a retention surface having different surfaces or edges that cooperate for securing external fiber optic connector 10 for creating the desired mechanical retention. For instance, the retention surface may be canted or have a vertical wall for tailoring the pull-out force for the connection port 236,236′. However, other geometries are possible for the securing member 310M of the securing feature 310.

Securing feature 310 may also include standoff 310SO for seating the securing feature resilient member 330 and centering the restoring force on the securing feature 310 when assembled as best shown in FIG. 4. The securing member 310M may also have a guide 310G. Other securing features 310 are possible with the concepts disclosed herein and may operate in a similar manner. For instance, the securing member 310M may comprise an opening instead of a bore that receives the external fiber optic connector therethrough.

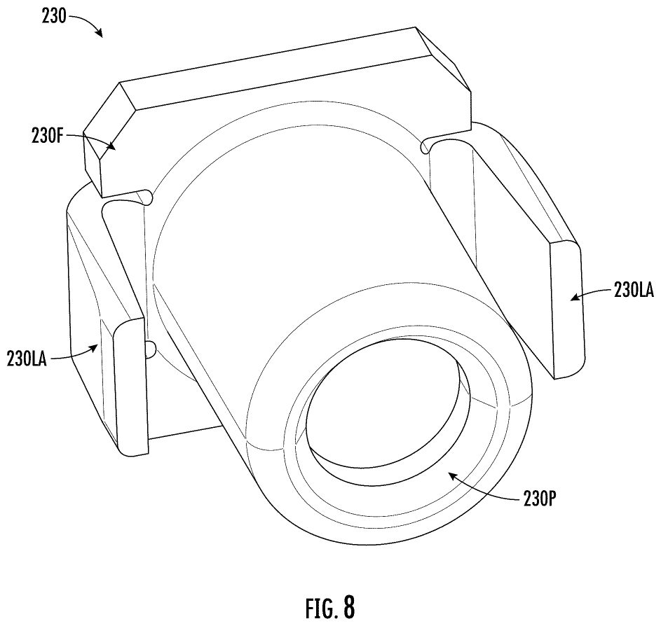

FIG. 8 is perspective view of the adapter 230 that cooperates with the shell 210 for capturing the ferrule alignment sleeve 232 disposed within the cavity 216 of the shell 210 of the extender port 200 when assembled. When assembled, the adapter 230 captures the ferrule alignment sleeve 232 is loosely captured so it may “float” relative to the shell 210. “Float” means that the ferrule alignment sleeve 232 can have slight movement in the X-Y plane for alignment and may be inhibited from over-traveling in the Z-direction along the axis of external fiber optic connector insertion so that suitable alignment may be made between mating external fiber optic connectors.

Adapter 230 comprises a passageway 230P extending from a flange 230F to the other end of the adapter 230. Adapter 230 also comprises one or more latch arms 230LA that are used for securing the adapter 230 to the barrel 210A of shell 210. Specifically, the adapter 230 is aligned so that the flange 230F faces the medial portion of the barrel 210A from the proper side of the barrel 210A to cooperate with the portion of the adapter that is integrally formed with barrel 210A. Latch arms 230LA are cantilevered so that they may flex inward when encountering suitable structure on the inside the passageway 215 of barrel 210A. Once the adapter 230A moves beyond the deflecting structure inside the passageway 215 of the barrel 210A, then the latch arms 230LA may spring back outward and be captured within the barrel 210A on a suitable ledge so that the adapter 230A is held in place. Depending on the design the adapter 230 the ferrule alignment sleeve 232 may positioned within the adapter 230 before assembly of the adapter into the barrel 210A or inserted into the receiving portion of the barrel 210A before the adapter 230 is assembled into the barrel 210A. Other designs or configurations for the adapter 230 are possible using the concepts disclosed herein.

The interface between the endcap 210B, 210C of shell 210 may have other structure or features for securing or sealing the components such as fasteners for securing the components of the shell or an adhesive, O-ring or gasket or weldable feature for sealing. Shells 210 may have any suitable shape, design or configuration as desired.

Securing feature 310 may also comprises one or more guides that cooperate with the shell 210 for keeping the bore 310B in the proper orientation within the shell, thereby keeping the locking feature 310L in the proper position within the respective securing feature guide 245 with respect to the connector insertion direction.

FIG. 9 is a bottom perspective view of the actuator 310A of the securing feature 310 that is configured as a push-button for extender port 200. The actuator 310A is associated with the respective connection port passageway 233 and translates within a portion of the securing feature guide 245. As shown, the actuator 310A is a push-button, but other configurations of the actuator are possible such as the actuator 310A being configured as a slider or rotating component used with an extender port 200 having one or more endcaps.

Actuator 310A may also comprise one or more structures such as latches 310L that cooperate with the barrel 210A of the shell 210 for retention. The latches 310L may be configured as a portion that extends from a body 310B of the actuator 310A and deflect upon insertion into the shell of the device. FIG. 9 shows a body 310B of that actuator 310A that comprises a top side, a bottom side and a circumferential groove 310G disposed between the top side and the bottom side. The top side of the actuator 310A is defined by the top rim that is visible after assembly into the device and the bottom side of the actuator 310A is defined by the lower rim above the latches 310L.

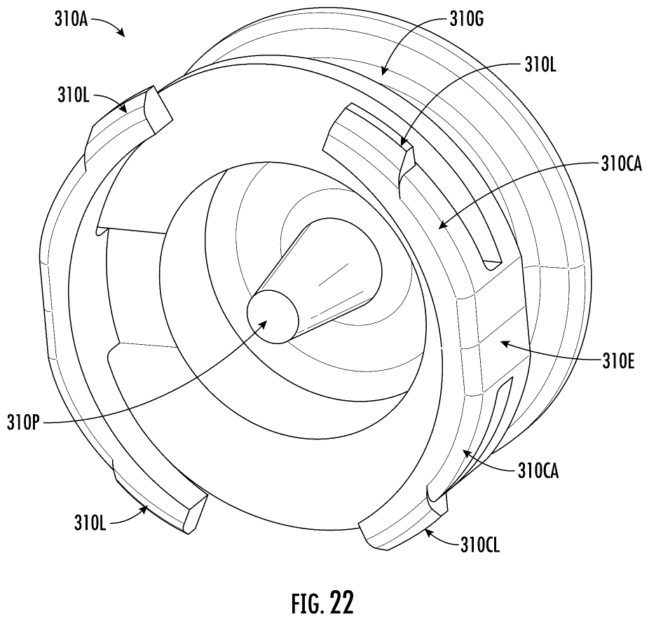

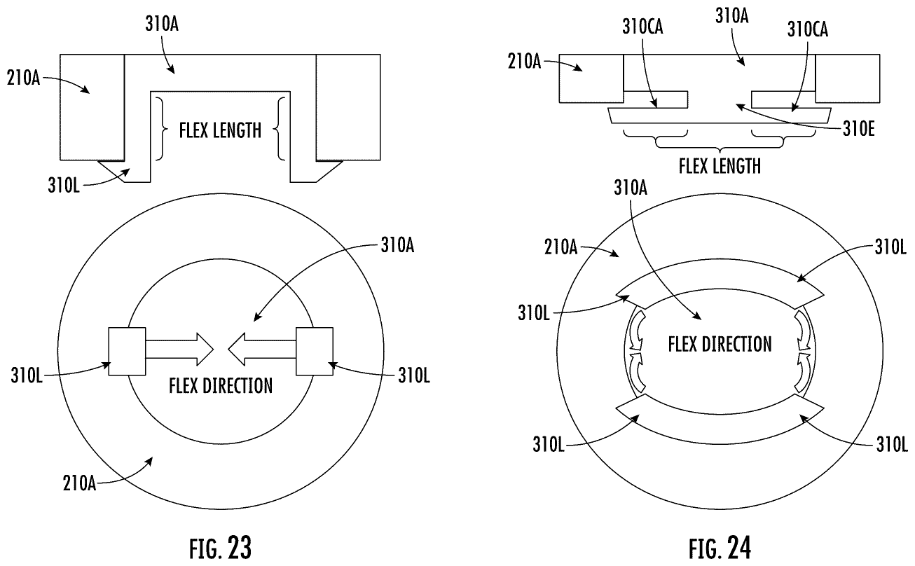

As shown, the latches 310A are spaced from the lower rim so they may deflect during assembly. Latches 310L allow a snap-fit assembly of the actuator 310A to the barrel 210A by aligning the actuator 310A with the securing feature guide 245 and then pushing the actuator 310A into the securing feature guide 245 to deflect the latches 310L in a suitable manner. Actuator 310A of FIG. 9 comprises latches 310L that deflect radially inward (e.g., one direction) for clearing the body of the barrel 310A and springing back to retain the actuator 310A with the barrel 210A of the shell 210. FIG. 22 schematically depicts the actuator 310A of FIG. 9 and shows a flex length for the latches 310L along with the flex direction for the latches 310L. As represented by the two inwardly facing arrows of FIG. 23, the latches 310L flex radially inward towards the insertion axis of the actuator 310A into the shell 210 during assembly (e.g., the insertion axis is into the image at the middle of the actuator 310A). These latches 310L of this actuator 310A deflect in one direction during assembly into the shell 210.

Actuator 310A may also comprise a protrusion 310P for engaging the securing member 310M of the securing feature 310. Protrusion 310P of actuator 310A is aligned with the push 310PU of the securing member 310M when assembled.

If desired, a sealing member 310S may also be disposed on the actuator 310A of the securing feature 310 as depicted in FIGS. 1 and 4. Sealing member 10S provides a seal between the securing feature 310 and the securing feature guide 245 of the shell 210 for inhibiting dirt, dust and debris from entering the extender port 200. If used, the sealing member 310S is disposed above the connector port passageway 233 for keeping dirt, debris, moisture and the like out of portions of the extender port 200. Sealing member 310S is sized for the retention groove 310G in the actuator 310A of securing feature 310 and cooperates with the wall of the securing feature guide 245 for sealing. If used, sealing member 310S is sized for cooperating with the groove 310G in the actuator 310A and the securing feature guide 245 for sealing and allowing translation of the actuator relative to the shell 210. The actuator 310A of securing feature 310 may also be a different color or have a marking indicia for identifying the port type or the like.

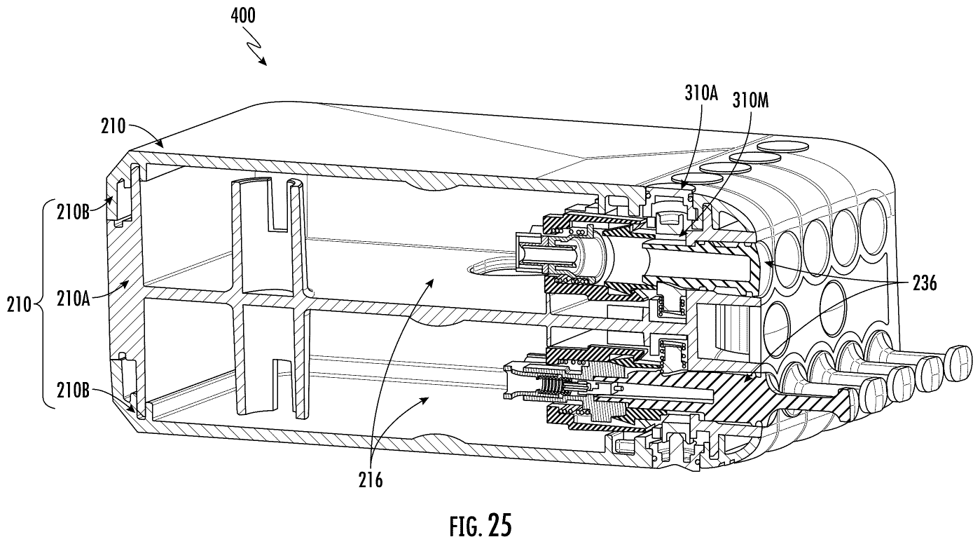

The push-button type actuators 310A disclosed herein may be used for cooperating with the securing member 310M in other suitable devices for securing and releasing an optical mating with the external fiber optic connector. For instance, actuators 310A may be used in terminals 400 having connection ports 236 such as depicted in FIG. 25.

Extender ports 200 may comprise other components or constructions if desired. By way of explanation, the sealing between the components of shell 210 may comprise a sealing element (not visible) disposed between the components or not. Instead of the extender port 200 receiving one or more appropriately sized O-rings or gaskets for weatherproofing extender port 200. Other embodiments may use an adhesive or suitable welding of the materials such as ultrasonic or induction welding with appropriate materials for sealing the extender port 200.

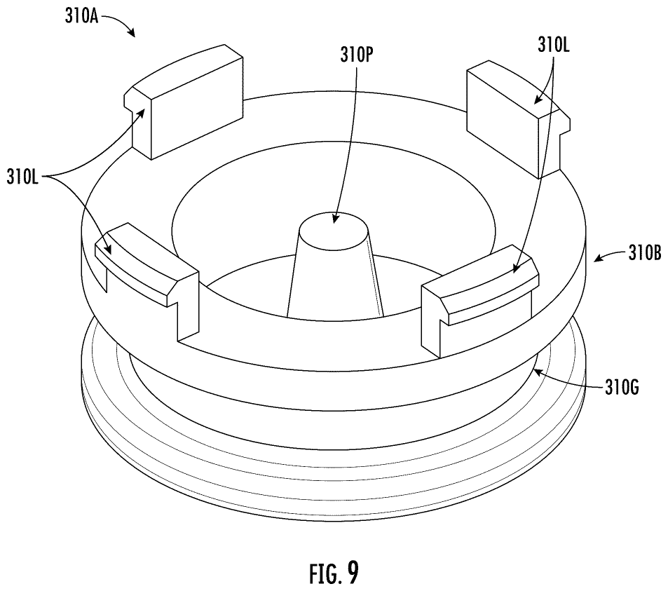

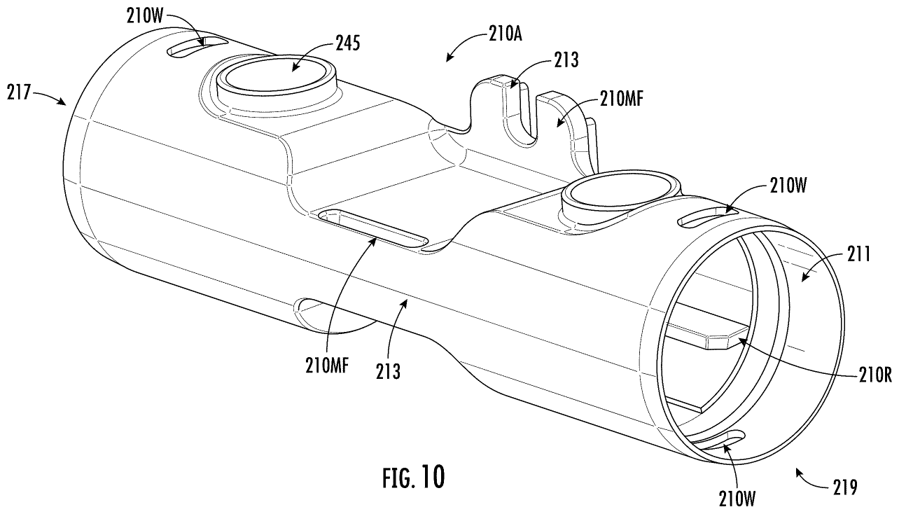

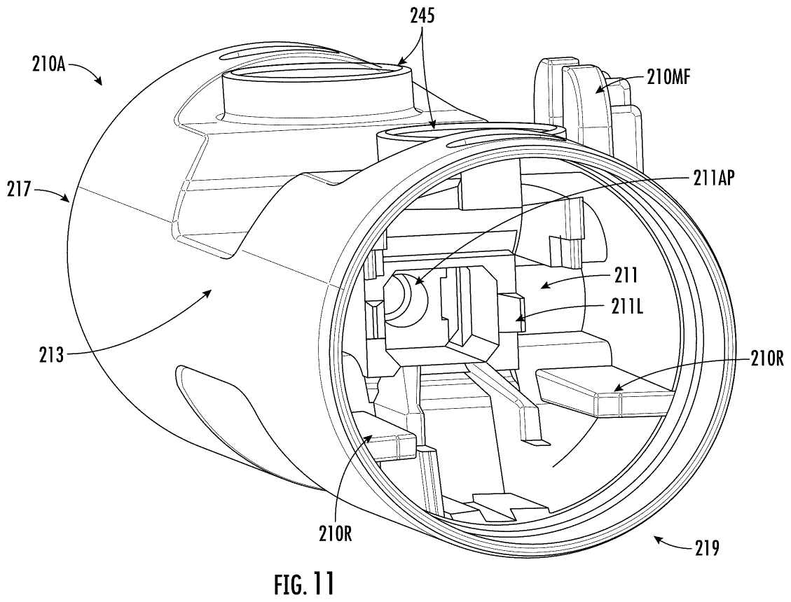

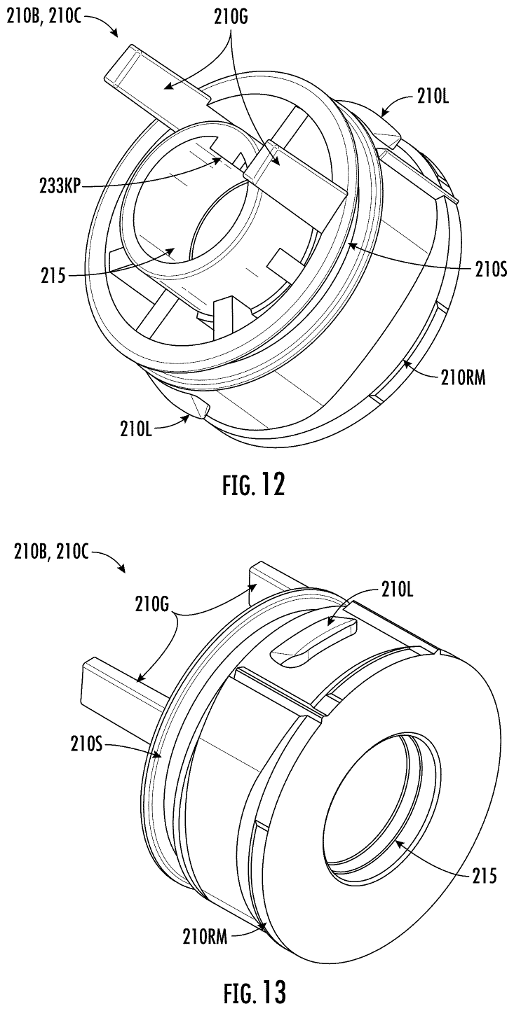

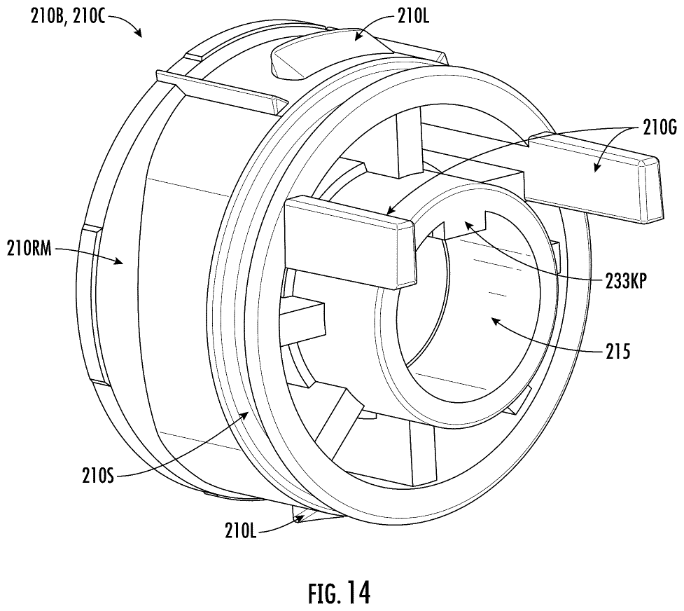

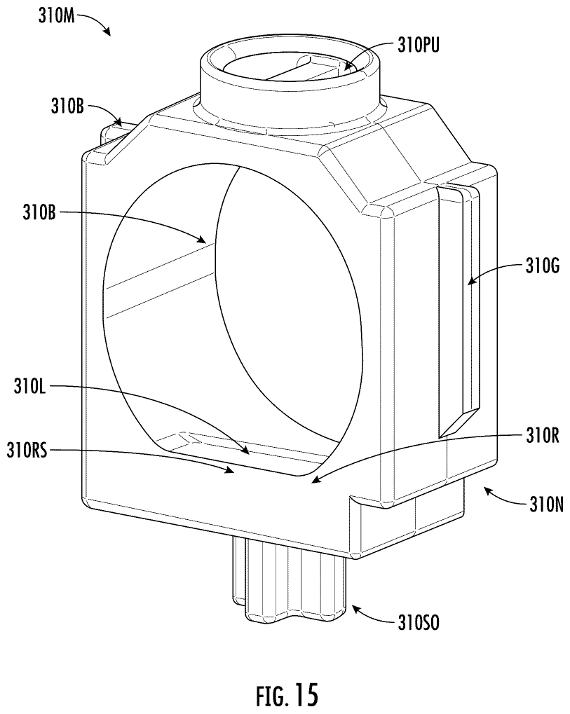

Other variations of explanatory extender ports 200 are also possible according to the concepts disclosed herein. FIGS. 10-14 are perspective views of components of another shell 210 for extender port 200 useful for optically mating one or more external fiber optic connectors 10. Specifically, FIGS. 10 and 11 are view of another barrel 210A and FIGS. 12-14 are views of end caps 210B, 210C that cooperate with barrel 210A shown in FIGS. 10 and 11. FIG. 15 is a view of the securing member 310M of securing feature 310 that cooperates with barrel 210A of FIGS. 10 and 11.

FIGS. 10 and 11 are perspective views of barrel 210A similar to the barrel 210A of FIG. 10 that is modified to cooperate with the components of FIGS. 12-15. Barrel 210A of FIGS. 10 and 11 comprises passageway 211 that extends along a longitudinal axis extending from first end 217 to second end 219 of the barrel 210A and has openings at the ends for receiving a portion of the respective endcaps 210B, 210C for forming the shell 210. Endcaps 210B, 210C may be configured so that they fit into the barrel 210A in only one orientation to inhibit assembly in an incorrect orientation or not. Barrels 210A disclosed comprise a portion of its passageway 211 configured as an alignment portion 211AP that is the region where optical mating occurs for one or more external fiber optic connectors 10 received in the device. By way of explanation, an alignment portion 211AP of passageway 211 of the barrel 210A may be sized for receiving ferrule alignment sleeve 232 as best shown in FIG. 11. Ferrule alignment sleeve 232 is used for receiving respective mating ferrule(s) of the one or more external fiber optic connectors 10. Barrel 210A may also include geometry as part of the passageway 211 that is configured for attaching adapter 230 or a portion thereof within the barrel 210A. By way of example, and not limitation, passageway 211 of barrel 210A may comprise a latching feature 211L formed therein so that a portion of the adapter 230 may engage and secure the adapter 230 and ferrule alignment sleeve 232 within the barrel 210A. For instance, the latching feature 211L formed in the passageway 211 of barrel may be sized for receiving the arms of adapter 230 with a suitable fit for securing the same in an appropriate manner.

Like the barrel 210A of FIG. 7, barrel 210A may include rails 210R may associated with each respective connection port 236,236′ of the device and are disposed within the passageway 211 of the barrel 210A running in a longitudinal direction on an internal sidewall such as shown if desired. Rails 210R of barrel 210A cooperate with other components of the extender port 200 for assembly. Rails 210R may be used for aiding with the rotational and/or positioning of the alignment of the securing member 310M within the passageway 211 of barrel 210A. For instance, a portion of the securing member 310M may be disposed between the rails 210R on opposing sides of the internal sidewall of the barrel 210A for rotational clocking. Further, the rails 216 shown in FIG. 11 operate to further allow only one orientation of assembly for the securing member 310M into the barrel 210A for proper orientation of the locking feature 310L. As shown in FIG. 11, rails 216 of barrel 210A are located at different elevations referenced from the bottom of the barrel 210A for providing an orientation feature so that the securing member 310M may only properly fit into the passageway 211 of barrel 210A in the correct orientation for the locking feature 310L during assembly. Specifically, the rails 216 being at different elevations in the passageway cooperate with orientation feature 310N of securing member 310M so it only fully-seats within the barrel 210A in the correction orientation due to the notch cooperating in one orientation where the locking feature 310L is properly arranged.

FIGS. 12-14 depict endcap 210B, 210C suitable for use with the barrel 210A of FIGS. 10 and 11. The endcap 210B, 210C of FIGS. 12-14 is similar to the endcap 210B, 210C shown in FIG. 6, and differences will be described herein. Endcaps 210B, 210C of FIGS. 12-14 also include guides 210G extending from the endcaps 210B, 210C for allowing the endcaps 210B, 210C to be assembled to the barrel 210A in only one orientation like the endcap 210B, 210C shown in FIG. 6. However, this endcap 210B, 210C positions the guides 210G closer to the keying feature 233KP on the interior side of the endcap as shown for cooperating with the barrel 210A of FIGS. 10 and 11. The guides 210G are configured as spaced apart arms extending inward toward the medial portion of the extender port 200 when assembled.

Like the endcap of FIG. 6, the endcaps 210B, 210C of FIGS. 12-14 each comprise respective openings 215 that extends through the endcap 210B, 210C and are sized for receiving a portion of the external fiber optic connector 10 received by the device. Further, endcap 210B, 210C of FIGS. 12-14 has retention features 210L configured as latches that cooperate with the retention features on the barrel 210A that are configured as windows for snap-fit assembly in a quick and reliable manner like other endcaps disclosed. Further, the endcap 210B, 210C may include seat 210S for receiving a sealing element such as an O-ring or gasket for sealing between the endcap 210B, 210C and the barrel 210A when assembled if desired.

FIG. 15 is a perspective view of a portion of the securing feature 310 for use with the shell of FIGS. 10-14 for making extender port 200. Specifically, FIG. 15 depicts securing member 310M that is similar to the securing member of FIG. 7. As depicted, this securing member 310M has a modified push 310PU compared with the securing member 310M of FIG. 7. Securing member 310M of FIG. 15 also has an orientation feature 310F for ensuring that the securing member 310M may only be properly assembled in the correct orientation for the locking feature 310L. Specifically, securing feature has the orientation feature 310N configured as a notched portion in the lower portion of the body so it only fully-seats into the barrel 210A with the locking feature 310L having the correct orientation for properly cooperating with a compliant external fiber optic connector 10 for securing the same in the device for mating.

Like the securing member 310M of FIG. 7, securing member 310M of FIG. 15 is a portion of securing feature 310 and comprises bore 310B aligned with the least one connection port passageway 233 when assembled and sized for receiving a suitable external fiber optic connector 10 therethrough for securing the same within the extender port 200. Bore 310B may also comprise features on the surface of the bore 310B for engaging with the external fiber optic connector 10 for securing the same within the respective connection port 236,236′ as disclosed herein. As shown, locking feature 310L is disposed within bore 310B of securing member 310M. In this case, locking feature 310L comprises a ramp 310R integrally formed at a portion of the bore 310B with the ramp angling up when looking into the respective connection port 236, 236′ when assembled. Securing feature 310 provides similar operation as discussed herein and may be biased to a retain position using securing feature resilient member 330. Ramp 310R may have any suitable geometry such as a retention surface such as a ledge at the backside or the ramp 310R may lead to a flat portion before the retention surface. Other variations of the concepts are also possible for use with extender ports 200.

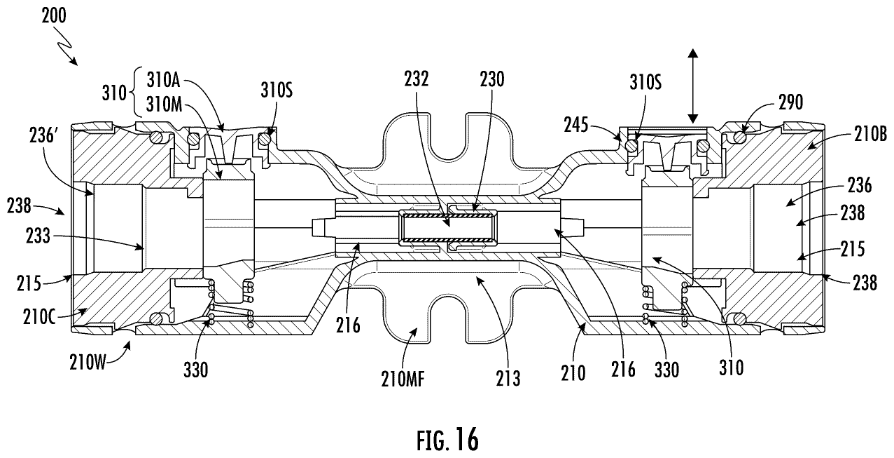

FIG. 16 is a cross-sectional view of the explanatory fiber optic extender port 200 using the components of FIGS. 10-15, and the assembly of these components is similar the extender port show 200 in FIGS. 1-4.

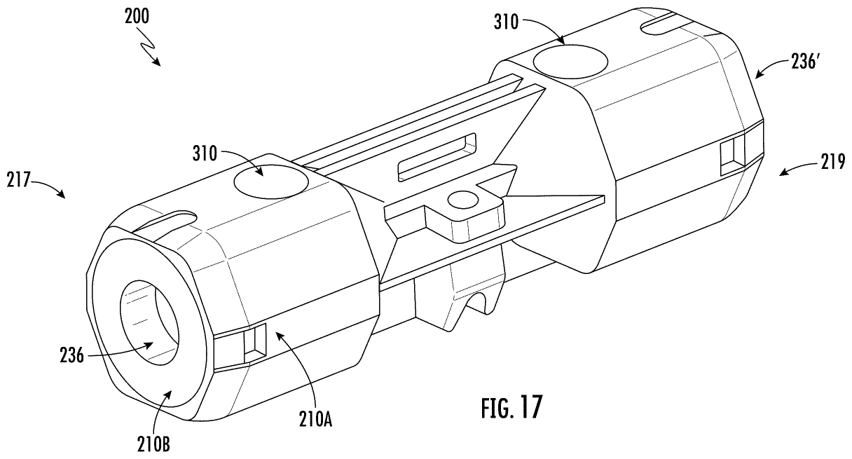

Other variation of the concepts disclosed are also possible. For instance, the concepts disclosed herein may be used with shells or barrels having different profiles as well. Barrels of extender ports can have any suitable shape for practicing the concepts disclosed. For instance, the barrel may have a square, rectangular profile or any other suitable profile while using one or more endcaps. Illustratively, FIG. 17 depicts another extender port 200 like the extender port of FIGS. 1-3 comprising a first connection port 236 and a second connection port 236′ that are aligned for making an optical connection between external fiber optic connectors 10 that are inserted from respective opposite ends of the extender port 200. Shell 210 comprises a barrel 210A and one or more endcap(s) 210B, 210C having respective openings 215 and defines cavity 216. As shown, the barrel 210A comprises a generally polygonal profile adjacent to the ends 217,219 of the barrel 210A along the longitudinal axis. As shown, the barrel 210A has a hexagonal profile adjacent to the ends 217,219 of the barrel 210A along the longitudinal axis. This extender port 200 also comprises at least one securing feature 310 associated with a respective connection port passageway 233 with a respective securing feature resilient member 330 for biasing a portion of the at least one securing feature 310 to the retain position. In other variations, the extender port 200 can be scalable to accommodate multiple optical matings with a single device. For instance, the extender port 200 may provide the barrel 210A of shell 210 with side-by-side adjacent connection port passageways 233 with respective components for providing the ability to mate/unmate two distinct sets of external fiber optic connectors 10 for making optical connections between the respective mating external fiber optic connectors 10. Concepts of the extender port may also be scaled to support other numbers of distinct optical connections such as three or four with a single device.

The present application also discloses methods for making extender ports. One method of making an extender port comprises providing a shell 210 comprising a barrel 210A and at least one endcap 210B, 210C having an opening 215 with the shell defining a cavity. The extender port 200 comprises a first connection port 236 having an optical connector opening 238 and a connection port passageway 233. The method includes assembling at least one securing feature 310 so it is associated with a connection port passageway 233 of the shell 210 securing and installing at least one securing feature resilient member 330 for biasing a portion of the at least one securing feature 310. The methods of making extender ports may further include installing other components as disclosed herein if desired. Once all of the internal components are installed into the barrel 210A, then the one or more respective endcaps 210B, 210C may then be attached at the respective openings at the end of the barrel 210A of shell 210. Other methods for making devices such as extender port 200 as disclosed herein are also contemplated.

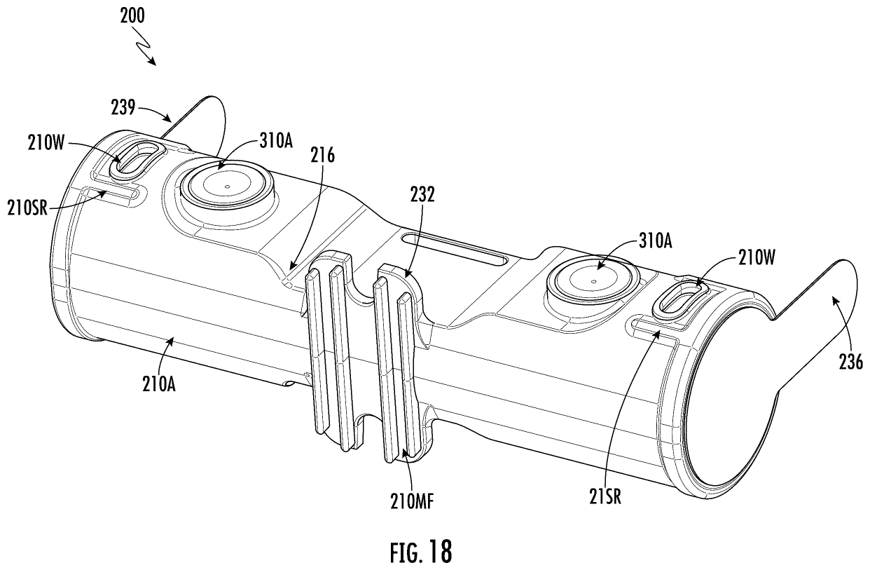

FIGS. 18-20 depict another extender port 200 having one or more end caps 210B, 210C and uses a different push-button actuator for translating the securing member and releasing a fiber optic connector from the device. The shell 210 of extender port also has other optional features as well. For instance, the shell 210 may include one or more ribs as desired. For instance, one or more strengthening ribs 210SR may be positioned about the window 210W of barrel 210A for added strength. The ends of the barrel 210A adjacent to the opening(s) may also have thickened walls if desired for strengthening as well. As shown, the ribs 210SR may extend into the thickened walls adjacent to the opening(s) of barrell 210A if desired. This extender port 200 also shows dust covers attached for protecting the connection ports 236 until ready for use.

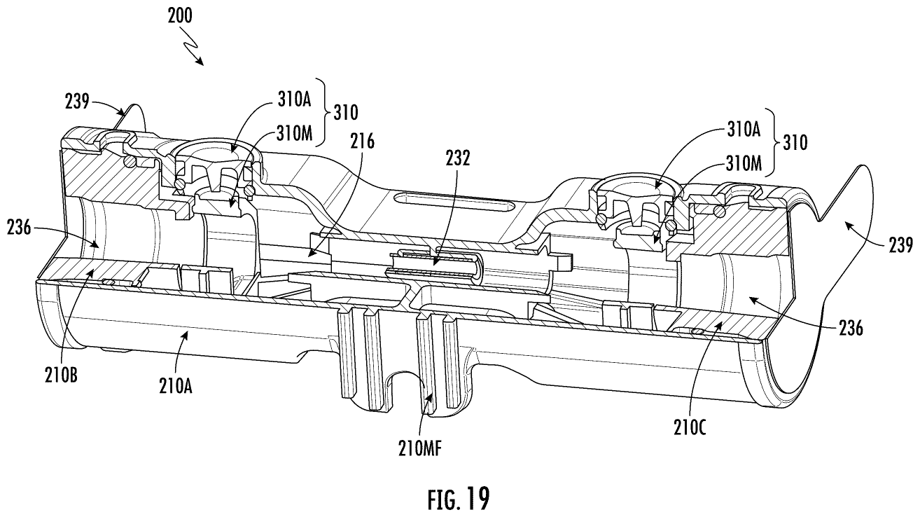

Any of the extender ports 200 may also have one or more dust covers 239 for protecting the connection ports 236 from dust, dirt or debris entering the extender port that may interfer with the optical performance. Thus, when the user wishes to make an optical connection to the extender port, the appropriate dust cover 239 is removed and then connector 10 of cable assembly 100 may be inserted into the respective connection port 236 for making an optical connection to the extender port 200. If desired, dust cover 239 may be configured as a plug that uses similar release and retain features as the connectors 10 for releasing the dust cover and being able to reinstall the plug into the connection port 236. By way of explanation, when securing feature 310 is pushed inward or down, the dust cover configured as a plug is released and may be removed. Other dust covers 239 are possible as well such as a removable cover that attaches to the end of the end cap 210B, 210C as shown in FIGS. 18 and 19. For instance, a suitable adhesive or the like may be used for placing the dust cover 239. Other methods are also possible for placing the dust cover 239 such as thermal swaging may be used for attaching the dust cover 239 such as a piece of foil, plastic or the like to a portion of the respective end cap. The dust cover 239 may also include a pull-tab that acts as a grip for removing the same from connection port 236 when desired for optical mating.

FIG. 19 a quarter-sectional view depicting another extender port 200 having one or more end caps (210B, 210C) and that uses a different push-button actuator 310A for translating the securing member for releasing a fiber optic connector from the device. Like the actuator 310 of FIG. 9, the latches 310L of actuator 310A of FIGS. 18-22 are spaced from the lower rim so they may deflect during assembly. This actuator 310A comprises latches 310L located on respective arcuate cantilevered arms 310CA that are spaced apart from the lower rim at the bottom side of the actuator 310A.

Actuator 310A of FIGS. 18-22 may also allow a low-profile height and/or a reduced stress profile during assembly. This actuator 310A arranges the deflection of the latches 310L in a different direction compared with the actuator of FIG. 9. Specifically, the latches of the actuator of FIG. 9 deflect inward in one direction as schematically shown in FIG. 23 and may cause a higher stress during deflection based on the flex length used. On the other hand, the design of FIGS. 18-22 has cantilevered arms that can be designed with a longer flex length for deflection using the same or even a shorter height compared with the actuator 310A of FIG. 9, thereby allowing a reduced the stress profile during assembly.

Latches 310L are disposed on the arcuate cantilevered arms 310CA and allow a snap-fit assembly of this actuator 310A to the barrel 210A by aligning the actuator 310A with the securing feature guide 245 and then pushing the actuator 310A into the securing feature guide 245 to deflect the latches 310L. The arcuate cantilevered arms 310CA provide a suitable geometry and flex length for reducing the stress profile for the deflection required for assembly into the device.

The actuator 310A of FIGS. 18-22 comprises latches 310L disposed on arcuate cantilevered arms 310CA that deflect in two directions for clearing the opening of the barrel 310A and springing back to retain the actuator 310A with the shell 210. The arcuate cantilever arms 310CA allow deflection in the direction of insertion axis of actuator 310A and also deflect radially inward toward the middle during assembly. Using the arcuate cantilevered arms 310A may provide a reduced stress profile on the actuator 310 during assembly and be easier to install.

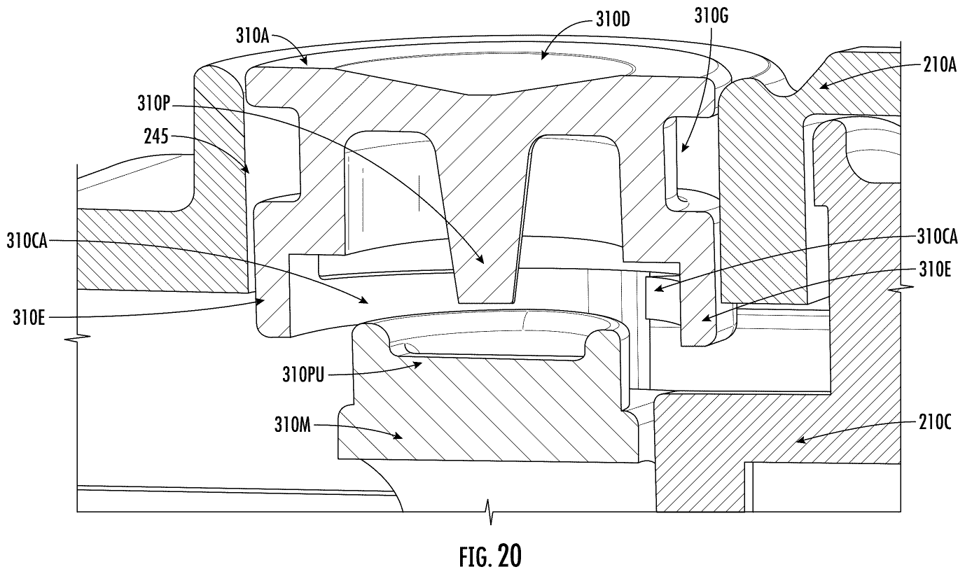

FIG. 20 is detailed sectional view of the extender port of FIGS. 18 and 19 showing the actuator 310A having arcuate cantilevered arms 310CA disposed within the securing feature guide 245 of shell 210 and shown assembled without a sealing member for clarity. As depicted, when assembled the latches 310L are used for retaining the actuator 310A in the shell. When assembled, the protrusion 310P of the actuator 310A is aligned with the push 310PU of the securing member 310M.

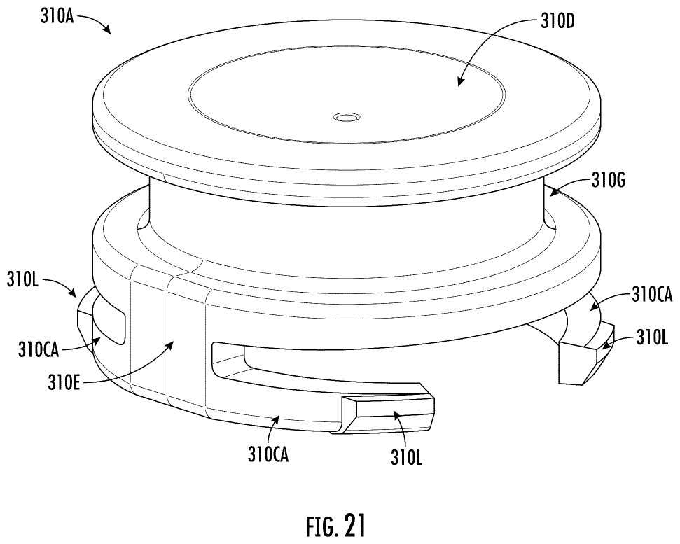

FIGS. 21 and 22 are a perspective views of the actuator shown in the devices of FIGS. 18-20 and 24 and depict the plurality of arcuate cantilevered arms 310CA used for retaining the actuator in the shell of the devices and used for releasing the optical mating. The arcuate cantilevered arms 310CA are connected to the body of the actuator 310A using an extension 310E. Extension 310E is the connecting point between the body of the actuator 310A and the arcuate cantilevered arm 310CA. Using extension 310E allows a creation of a gap or space between each arcuate cantilevered arm 310CA and the body of the actuator 310A. Each arcuate cantilevered arm 310CA may be attached to the extension 310E. As shown, two arcuate cantilevered arms 310CA may be attached to a common extension 310E if desired. The arcuate cantilevered arms 310CA can generally follow the round profile of the body such as shown. Each latch 310L is disposed adjacent the free end of the respective arcuate cantilevered arm 310CA and may face radially outward as shown.

Although, the actuator 310A of FIGS. 18-22 has four arcuate cantilevered arms 310CA respectively attached to two extensions 310E, the actuator using the concepts of arcuate cantilevered arms can have other configurations. For instance, an actuator 310A can comprise three arcuate cantilevered arms 310S each being attached to a respective extension 310E extending from the body of the actuator 310A. Further, the actuators 310A disclosed herein may be used with other devices having connection ports for optical mating of external connectors such as terminals as depicted in FIG. 25.

FIG. 24 schematically depicts the actuator 310A of FIGS. 18-22 and shows a flex length for the latches 310L along with the deflection direction in the two directions for the latches 310L of arcuate cantilevered arms 310CA. As represented by the arrows of FIG. 24, the latches 310L of the arcuate cantilevered arms 310CA are deflected in two directions. The latches flex radially inward towards the insertion axis of the actuator 310A into the shell 210 during assembly (e.g., the insertion axis is into the image.

These latches 310L of the actuator 310A of FIG. 24 deflect in two directions during assembly compared with the schematic representation of the actuator of FIG. 9 shown in FIG. 23. As shown in FIG. 24, the flex length of the actuator of FIGS. 18-22 is in the horizontal direction compared to the flex length being in the vertical direction for the actuator 310A represented by FIG. 23.

Other devices may use the actuators disclosed herein for releasing an external fiber optic connector from a connection port of the device. For instance, FIG. 25 is a cross-sectional view of a terminal 400 having connection ports 236 for receiving external fiber optic connectors and making optical connections. As depicted, the terminal 400 has securing features 310 that comprise securing members 310M and actuator 310A as disclosed herein. The actuator 310A is attached to the shell 210 using the latches 310L disposed on respective arcuate cantilevered arms 310CA. Also, the connection port 236 may be a portion of the shell 210. In this embodiment a three-piece shell 210 is used having a first component 210A with the connection ports 236 being a portion of the first component 210A and second and third components 210B that attach to the first component 210A. As shown, the terminal 400 has two rows of connection ports 236 and the actuators 310A are disposed on opposite sides of the terminal 400 for the two rows of connection ports 236. Other terminals can use the actuators 310A disclosed herein as well.

Although the disclosure has been illustrated and described herein with reference to explanatory embodiments and specific examples thereof, it will be readily apparent to those of ordinary skill in the art that other embodiments and examples can perform similar functions and/or achieve like results. For instance, the connection port endcaps may be configured for tailoring the device to the desired external connector. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

We claim:

1. An extender port for making an optical connection with an external fiber optic connector, the extender port comprising:
a shell comprising a barrel and at least one endcap having an opening, wherein the shell defines a passageway having a cavity;
a first connection port disposed on the extender port with the at least one connection port comprising an optical connector opening extending from the opening of the at least one endcap into the cavity of the extender port and defining a first connection port passageway;
at least one securing feature associated with the first connection port passageway; and
at least one securing feature resilient member for biasing a portion of the at least one securing feature.

2. The extender port of claim 1, further comprising at least one securing feature guide formed as a portion of the barrel, wherein a portion of the at least one securing feature is disposed within a portion of the at least one securing feature guide.

3. The extender port of claim 1, further comprising a tether cable having at least one optical fiber, the tether cable is attached to the extender port so that the at least one optical fiber is aligned with the at least one connection port.

4. The extender port of claim 1, wherein the at least one endcap comprises a keying feature disposed within the opening.

5. An extender port of claim 1, further comprising a second end cap having a second opening, and a second connection port comprising a second optical connector opening extending from the opening of the second end cap into the cavity of the extender port and defining a second connection port passageway, the second connection port passageway being aligned with the first connection port passageway.

6. The extender port of claim 1, further comprising a ferrule alignment sleeve disposed within the cavity of the shell.

7. The extender ports of claim 1, wherein the at least one securing feature is capable of translating within the shell for securing and releasing an external fiber optic connector from the first connection port.

8. The extender port of claim 1, wherein of the at least one securing feature is biased to a retain position.

9. An extender port for making an optical connection between external fiber optic connectors, the extender port comprising:
a shell comprising a barrel, a first endcap having a first opening and a second endcap having a second opening, wherein the shell defines a passageway having a cavity;
a first connection port disposed on the extender port with the first connection port comprising a first optical connector opening extending from the opening of first endcap into the cavity and defining a first connection port passageway;
a second connection port disposed on the extender port with the second connection port comprising a second optical connector opening extending from the opening of the second endcap into the cavity and defining a second connection port passageway, the second connection port passageway being aligned with the first connection port passageway; and
at least one securing feature associated with the first connection port passageway, wherein a portion of the at least one securing feature is capable of translating within a portion of the shell.

10. The extender port of claim 9, wherein the first endcap comprises a keying feature disposed within the first opening.

11. The extender port of claim 9, wherein the at least one securing feature comprise a locking member and an actuator.

12. The extender port of claim 9, wherein the at least one securing feature comprises a bore that is aligned with the first connection port passageway.

13. An extender port for making optical connection between external fiber optic connectors, the extender port comprising:
a shell comprising a barrel, a first endcap having a first opening and a second endcap having a second opening, wherein the shell defines a cavity;
a first connection port disposed on the extender port with the first connection port comprising a first optical connector opening extending from the opening of first endcap into the cavity and defining a first connection port passageway;
a second connection port disposed on the extender port with the second connection port comprising a second optical connector opening extending from the opening of the second endcap into the cavity and defining a second connection port passageway, the second connection port passageway being aligned with the first connection port passageway;
a first seal disposed between the first endcap and the barrel;
a second seal disposed between the second endcap and the barrel; and
at least one securing feature associated with the first connection port passageway.

14. The extender port of claim 13, wherein the at least one securing feature translates from a retain position to an open position as a suitable fiber optic connector is inserted into the at least one connection port.

15. The extender port of claim 13, wherein the at least one securing feature is capable of releasing an external fiber optic connector when translating within a portion of the at least one securing feature guide.

16. The extender port of claim 13, wherein the at least one securing feature is capable of moving to a retain position automatically when a suitable external fiber optic connector is fully-inserted into the first connector port passageway.

17. The extender port of claim 13, wherein the at least one securing feature comprises a locking feature.

18. The extender port of claim 13, wherein the at least one securing feature comprises a locking feature, wherein the locking feature comprises a ramp with a ledge.

19. The extender port of claim 13, further comprising a ferrule alignment sleeve disposed within the cavity of the shell.

20. The extender port of claim 13, wherein the first endcap comprises a snap-fit assembly with the barrel.

21. The extender port of claim 13, wherein the first endcap comprises a keying feature disposed in the opening.

22. An extender port for making optical connection between external fiber optic connectors, the extender port comprising:
a shell comprising a barrel, a first endcap having a first opening and a second endcap having a second opening, wherein the shell defines a cavity comprising a passageway between the first opening and the second opening;
a first connection port disposed on the extender port with the first connection port comprising a first optical connector opening extending from the opening of first endcap into the cavity and defining a first connection port passageway;
a second connection port disposed on the extender port with the second connection port comprising a second optical connector opening extending from the opening of the second endcap into the cavity and defining a second connection port passageway, the second connection port passageway being aligned with the first connection port passageway; and
at least one securing feature associated with the at least one connection port passageway, and the at least one securing feature comprises a bore, and the at least one securing feature is capable of translating within a portion of the shell wherein the at least one securing feature translates from a retain position to an open position as a suitable fiber optic connector is inserted into the at least one connection port.

23. The extender port of claim 22, wherein the bore is sized for receiving a suitable external fiber optic connector therethrough.

24. The extender port of claim 23, wherein the bore comprises a locking feature.

25. The extender port of claim 22, wherein the locking feature comprises a ramp with a ledge.

26. The extender port of claim 22, further comprising at least one securing feature resilient member for biasing a portion of the at least one securing feature.

27. The extender port of claim 22, further comprising a ferrule alignment sleeve disposed within the cavity of the shell.

28. An extender port for making an optical connection between external fiber optic connectors, the extender port comprising:
a shell comprising a barrel, a first endcap having a first opening and a second endcap having a second opening, wherein the shell defines a cavity;
a first connection port disposed on the extender port with the first connection port comprising a first optical connector opening extending from the opening of first endcap into the cavity and defining a first connection port passageway;
a second connection port disposed on the extender port with the second connection port comprising a second optical connector opening extending from the opening of the second endcap into the cavity and defining a second connection port passageway, the second connection port passageway being aligned with the first connection port passageway;
a ferrule alignment sleeve disposed within the cavity of the shell; and
at least one securing feature associated with the at least one connection port passageway, and the at least one securing feature comprises a bore and a locking feature, and the at least one securing feature is capable of translating within a portion of shell, and wherein the at least one securing feature translates from a retain position to an open position as a suitable external fiber optic connector is inserted into the at least one connection port.

29. The extender port of claim 28, wherein the locking feature comprises a ramp with a ledge.

30. The extender port of claim 28, wherein the locking feature comprises a retention surface.

31. The extender port of claim 28, further comprising a ferrule alignment sleeve disposed within the cavity of the shell.

32. An extender port for making an optical connection between external fiber optic connectors, the extender port comprising:
a shell comprising a barrel, a first endcap having a first opening and a second endcap having a second opening, wherein the shell defines a cavity;
a first connection port comprising an optical connector opening extending from an outer surface of the extender port into the cavity and defining a connection port passageway;
a second connection port comprising a second optical connector opening extending from an outer surface of the extender port into the cavity and defining a second port passageway, the second connection port passageway being aligned with the first connection port passageway; and
a first securing feature associated with the first connection port passageway, and the first securing feature comprising a locking member and an actuator, and the first securing feature is capable of translating relative to the shell, wherein the first securing feature translates from a retain position to an open position as a suitable external fiber optic connector is inserted into the first connection port.

33. The extender port of claim 32, further comprising at least one securing feature guide formed as a portion of the barrel, wherein a portion of the at least one securing feature translates along the at least one securing feature guide.

34. The extender port of claim 32, wherein the first connection port and the second connection ports are portions of the shell.

35. The extender port of claim 32, further comprising further comprising a ferrule alignment sleeve disposed within the cavity of the shell.

36. The extender port of claim 32, wherein the first endcap comprises a keying portion disposed in the first opening.

37. The extender port of claim 32, further comprising a sealing feature disposed on the at least one securing feature.

38. The extender port of claim 32, the extender port comprises at least one O-ring disposed between the first endcap and the barrel.

39. The extender port of claim 32, further comprising at least one securing feature guide formed as a portion of the barrel, at least a portion of one securing feature guide is arranged transversely to a longitudinal axis of the first connector port passageway.

40. The extender port of claim 32, further comprising at least one securing feature resilient member for biasing a portion of the at least one securing feature to a retain position.

41. The extender port of claim 32, wherein the barrel comprises a mounting feature.

42. The extender port of claim 32, further comprising a sealing feature disposed on the actuator of the securing feature.

43. The extender port of claim 42, wherein the sealing feature is an O-ring disposed between the actuator and a portion of the shell.

44. The extender port of claim 32, wherein the extender port is weatherproof.

45. The extender port of claim 32, wherein the first connection port retains a suitable external fiber optic connector when the external fiber optic connector is fully-seated within the first connection port.

46. A method of making an extender port for making an optical connection with an external fiber optic connector, the extender port comprising:
providing a shell comprising a barrel and a first endcap having an opening, wherein the shell defines a cavity and a first connection port, and the first connection port comprising a first optical connector opening extending from the opening of the first endcap into the cavity and defining a first connection port passageway;
assembling a first securing feature into the cavity so it is associated with a first connection port passageway of the shell;
installing a first securing feature resilient member for biasing a portion of the first securing feature; and
attaching the first endcap to the barrel.

47. The method of claim 46, wherein the first securing feature translates from a retain position to an open position as a suitable external optic connector is inserted into the first connection port.

48. The method of claim 46, wherein the first securing feature is capable of releasing an external fiber optic connector when translating within a portion of the at least one securing feature guide formed by the shell.

49. The method of claim 46, wherein the first securing feature is capable of moving to a retain position automatically when a suitable external fiber optic connector is fully-inserted into the first connector port passageway.

50. The method of claim 46, wherein the first securing feature comprises a locking feature.

51. The method of claim 46, wherein the first securing feature comprises a locking feature, wherein the locking feature comprises a ramp with a ledge.

52. The method of claim 46, further comprising a second connection port disposed on the extender port with the second connection port comprising a second optical connector opening extending from an end of the second endcap into the cavity of the extender port and defining a second connection port passageway, and a second securing feature associated with the second connection port passageway for securing a suitable second external fiber optic connector.

53. The method of claim 52, wherein the second securing feature comprises a locking feature having a ramp with a ledge.

54. An actuator configured as a push-button used for releasing an optical connector mating with a suitable device, the actuator comprising:
a body comprising a top side, a bottom side and a circumferential groove disposed between the top side and the bottom side, wherein the bottom side comprises a plurality of arcuate cantilevered arms with each arcuate cantilevered arm having a latch for securing the actuator when assembled.

55. The actuator of claim 54, wherein the plurality of arcuate cantilevered arms are configured to flex in two directions relative to the insertion direction of the actuator during assembly.

56. The actuator of claim 54, wherein the plurality of arcuate cantilevered arms are connected to the body using an extension for creating a gap between the body and the plurality of arcuate cantilevered arms.

57. The actuator of claim 54, the plurality of arcuate cantilevered arms comprising at least three arcuate cantilevered arms.

58. The actuator of claim 54, wherein the actuator is a portion of terminal or extender port used for making an optical connection.
